(19) United States
(12) Patent Application Publication
(10) Pub. No.: US 2011/0000966 A1
(43) Pub. Date: Jan. 6, 2011

(54) BARCODE READING DEVICE

(76) Inventor: Shu-Shien LIU, Tainan City (TW)

Correspondence Address: Muncy, Geissler, Olds & Lowe, PLLC, 4000 Legato Road, Suite 310, FAIRFAX, VA, 22033, US

(21) Appl. No.: 12/830,795

(22) Filed: Jul. 6, 2010

Related U.S. Application Data
(60) Provisional application No. 61/223,234, filed on Jul. 6, 2009.

(51) Int. Cl. G06K 7/10

(52) U.S. Cl. 235/462.42; 235/462.41

(57) ABSTRACT

A barcode reading device for reading a barcode includes a case, a transmissive light-guiding element, an image capturing module, a light source and a light control element. The case has an opening. The transmissive light-guiding element is disposed adjacent to the opening and has a first surface, a second surface and a connecting surface for connecting the first surface and the second surface. The image capturing module is disposed in the case and captures an image of the barcode through the second surface and the first surface. The light source emits a light beam to the connecting surface. The light control element controls the ON/OFF of the light source.

### CROSS REFERENCE TO RELATED APPLICATIONS

This application claims the benefit of U.S. Provisional Patent Application No. 61/223,234 entitled BARCODE READING DEVICE, inventor Shu-Shien LIU, filed Jul. 6, 2009, and incorporated herein by reference.

### BACKGROUND OF THE INVENTION

1. Field of Invention

The invention relates to a reading device and, in particular, to a barcode reading device.

2. Related Art

The barcode reading device is a common input device widely applied in logistics management, sales management or information transmission. For example, the barcode can be directly printed on the package or tag of goods, so that the barcode reading device can read the barcode to retrieve the corresponding information of the goods.

As shown in FIG. 1, a barcode reading device 1 includes a light source module 11, a bottom 12, a reflecting mirror 13, a lens 14, an image sensor 15, and a processor 16. The switch 12 is used to control the ON/OFF of the light source module 11.

When the user uses the barcode reading device 1 to align with a barcode 2 and then presses the bottom 12, the light source module 11 can emit a light beam 111 projected on the barcode 2. The barcode 2 can reflect the light beam 111 to generate a reflected light beam 131, which is then reflected by the reflecting mirror 13 and passing through the lens 14. After that, the image sensor 15 senses the reflected light beam 131 so as to output a barcode sensing signal, and the processor 16 outputs a digital barcode data according to the barcode sensing signal. The digital barcode data is transmitted to an information system for further processing or specific purpose.

In addition, the barcode data can be applied in stores, supermarkets or malls. For example, the information system installed at the counter of the store can process the digital barcode data, so that the goods information corresponding to the digital barcode data can be shown on the monitor.

However, the conventional barcode reading device can only provide the better reading effect with respective to the barcode printed on the medium such as publication or papers. Regarding to the barcode displayed on the screen of mobile phone, the conventional barcode reading device can not perfectly recognize it. This is because the publication and the screen of the mobile phone have obviously different white balance properties. In general, the conventional barcode reading device is designed for the white balance property of one particular object.

Therefore, it is an important subject of the invention to provide a barcode reading device that is suitable for the objects with different white balance properties and thus can perfectly read the barcode shown on different objects.

### SUMMARY OF THE INVENTION

In view of the foregoing, the present invention is to provide a barcode reading device that is suitable for objects with different white balance properties.

To achieve the above, the present invention discloses a barcode reading device for reading a barcode. The barcode reading device includes a case, a transmissive light-guiding element, an image capturing module, a light source and a light control element. The case has an opening. The transmissive light-guiding element is disposed adjacent to the opening and has a first surface, a second surface and a connecting surface for connecting the first surface and the second surface. The image capturing module is disposed in the case and captures an image of the barcode through the second surface and the first surface. The light source emits a light beam to the connecting surface. The light control element controls the ON/OFF of the light source.

To achieve the above, the present invention discloses a barcode reading device for reading a barcode. The barcode reading device includes a case, a transmissive light-guiding element, an image capturing module, a light source and a light control element. The case has an opening. The transmissive light-guiding element is disposed adjacent to the opening and has a first surface and a second surface disposed opposite to each other. The image capturing module is disposed in the case and captures an image of the barcode through the second surface and the first surface. The light source emits a light beam to the first or second surface. The light control element controls the ON/OFF of the light source.

As mentioned above, in the barcode reading device of the present invention, the light beam emitted from the light source enters the transmissive light-guiding element, and the transmissive light-guiding element can guide the entered light beam to the first surface, so that the total light quantity reaching the first surface can be increased. The light beam towards the first surface can be reflected by the barcode, and the reflected light beam passes through the first surface to enter the transmissive light-guiding element and is then outputted through the second surface. After that, the image capturing module can retrieve the light beam reflected by the barcode so as to capture the image of the barcode. Accordingly, the barcode reading device of the present invention can be suitable for two or more objects with different white balance properties, so that it can perfectly recognize the barcodes shown on different objects.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional barcode reading device;

FIG. 2A is a schematic 3D diagram of a barcode reading device of an embodiment of the present invention;

FIG. 2B is a side view of that shown in FIG. 2A;

FIG. 3A to FIG. 3C are schematic diagrams showing the light paths of the transmissive light-guiding element according to an embodiment of the present invention;

FIG. 4 and FIG. 5 are schematic diagrams showing the media according to an embodiment of the present invention;

FIG. 6 is a flow chart of the operation of the barcode reading device according to an embodiment of the present invention;

FIG. 7 is a schematic diagram showing a barcode reading device according to another embodiment of the present invention;

FIG. 8 is a flow chart of a control method of the barcode reading device according to another embodiment of the present invention;

FIG. 9 is a schematic diagram showing a barcode reading device according to another embodiment of the present invention;

FIG. 10 is a flow chart of a control method of the barcode reading device according to another embodiment of the present invention;

FIGS. 11 to 16 are schematic diagrams showing various aspects of the light source according to another embodiment of the present invention;

FIGS. 17 to 18 are schematic diagrams showing various aspects of the image capturing module according to another embodiment of the present invention;

FIG. 19 is a schematic diagram showing another aspect of the image capturing module according to another embodiment of the present invention;

FIG. 20 and FIG. 21 are schematic diagrams showing a barcode reading device according to another embodiment of the present invention; and

FIG. 22 and FIG. 23 are schematic diagrams showing various aspects of the transmissive light-guiding element according to another embodiment of the present invention.

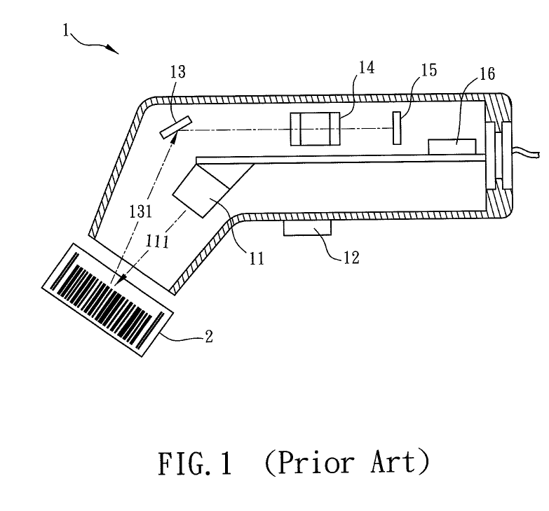

### DETAILED DESCRIPTION OF THE INVENTION

The present invention will be apparent from the following detailed description, which proceeds with reference to the accompanying drawings, wherein the same references relate to the same elements.

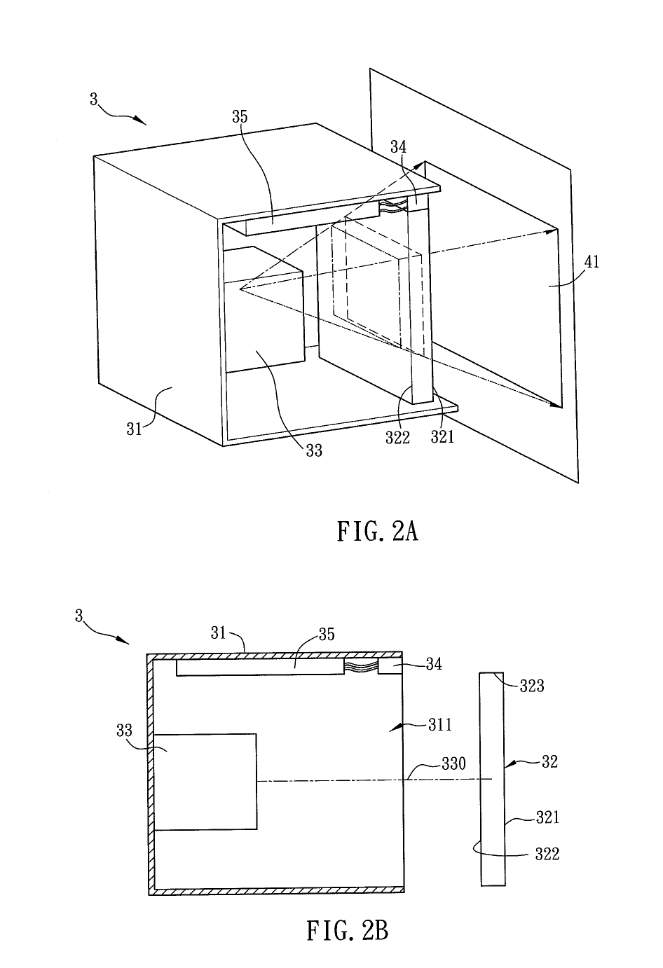

With reference to FIG. 2A and FIG. 2B, a barcode reading device 3, which is used for reading a barcode 41, includes a case 31, a transmissive light-guiding element 32, an image capturing module 33, a light source 34 and a light control element 35.

The case 31 has an opening 311. The transmissive light-guiding element 32 is disposed adjacent to the opening 311 and has a first surface 321, a second surface 322 and a connecting surface 323, which connects the first surface 321 and the second surface 322. The image capturing module 33 is disposed in the case 31 and captures an image of the barcode 41 through the second surface 322 and the first surface 321. The light source 34 emits a light beam to the connecting surface 323. The light control element 35 controls the ON/OFF of the light source 34.

The first surface 321 and the second surface 322 are disposed opposite to each other. The first surface 321 faces the barcode 41, and the second surface 322 faces the image capturing module 33.

In this embodiment, the transmissive light-guiding element 32 is disposed in the opening 311, so that it can be used as a cap of the barcode reading device 3. Alternatively, the transmissive light-guiding element 32 may be disposed inside or outside the opening 311.

The transmissive light-guiding element 32 guides the entered light beam toward the first surface 321. The barcode 41 reflects the light beam outputted from the first surface 321, and then the light beam reflected by the barcode 41 passes through the first surface 321 and the second surface 322 in order.

An incident light axis 330 of the image capturing module 33 is perpendicular to the second surface 322. The image capturing module 33 captures the image of the barcode 41 through the transmissive light-guiding element 32. In this case, the light beam, which is necessary for the image capturing module 33 to capture the image, is inputted through the connecting surface 323 and then outputted through the first surface 321. Thus, the light is bright enough to illuminate the barcode 41.

In order to reach a better image capturing effect, the distance between the barcode 41 and the first surface 321 should not be too large. In other words, if the barcode 41 can be closer to or contacted with the first surface 321, the light emitted from the first surface 321 is positively bright enough to illuminate the barcode 41.

To be note, if the light emitted from the first surface 321 is bright enough, the barcode reading device 3 can be applied to different media with different white balance properties. Accordingly, the image capturing module 33 can exactly retrieve the image of the barcode shown on different media with different white balance properties.

The light source 34 and the connecting surface 323 may be separated with a certain distance for facilitating heat dissipation. However, the distance between the light source 34 and the connecting surface 323 should not be too large. Moreover, if the heat dissipation efficiency can be enhanced, the light source 34 and the connecting surface 323 may be contact with each other.

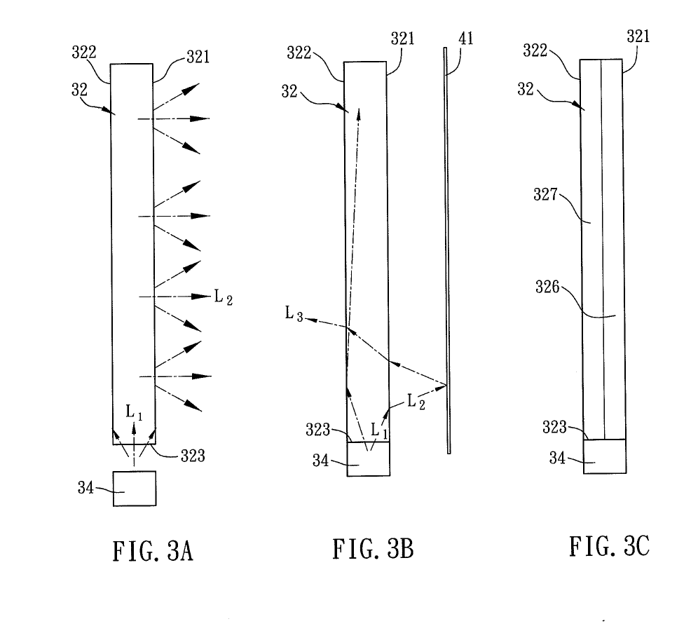

Referring to FIGS. 3A and 3B, the light beam L1 emitted from the light source 34 enters the transmissive light-guiding element 32 through the connecting surface 323. The transmissive light-guiding element 32 guides the entered light beam L1 toward the first surface 321. Then, the barcode 41 reflects the light beam L2 outputted from the first surface 321 to generate the reflected light beam L3.

The transmissive light-guiding element 32 is light permeable. The light beam L3 passes through the first surface 321 and the second surface 322, and then reaches the image capturing module 33 disposed in the case 31. Thus, the image capturing module 33 can retrieve the image of the barcode 41.

The area of the connecting surface 323 is smaller than that of the first surface 321. The light beam entered through the connecting surface 323 is guided within the transmissive light-guiding element 32 and then distributed on the first surface 321. The light source 34 can be a line light source or a plane light source with a small area. After passing through the transmissive light-guiding element 32, the light beam can be transformed to be a lighting surface with larger area on the first surface 321.

In this embodiment, the space inside the case 31 is filled with air, which has a refractive index of approximate 1 while the refractive index of the transmissive light-guiding element 32 is larger than 1 (e.g. larger than 1.3). Due to the difference between the refractive indexes, when the light beam reaches the second surface 322, it will be refracted or be reflected. Part of the light beam traveling toward the second surface 322 will be totally reflected and then travels toward the first surface 321. The light beam traveling toward the first surface 321 may pass through the first surface 321. Of course, the light refraction and total reflection may occur at the first surface 321. If the light refraction and total reflection occur at both the first surface 321 and the second surface 322, the light beam will travel inside the transmissive light-guiding element 32. Accordingly, the transmissive light-guiding element 32 can guide the light beam to travel inside the transmissive light-guiding element 32 and then to be outputted through the first surface 321.

The transmissive light-guiding element 32 can be made of a light-permeable material. Most of the second surface 322 is a smooth surface, which may avoid interference when the image capturing module 33 captures the image of the barcode 41. The smooth surface is, for example, a surface without roughness, microstructures or reflective elements. Of course, the second surface 322 can be entirely a smooth surface.

The first surface 321 is similar to the second surface 322. That is, most of the first surface 321 is a smooth surface, or the entire first surface 321 is a smooth surface.

The configuration of the smooth surface can allow the transmissive light-guiding element 32 to provide a larger light passing area for the light beam traveling from the barcode 41 to the image capturing module 33. On the other hand, to enhance the light source can provide enough light outputted from the first surface 321 to illuminate the barcode 41. Besides, since the light beam has some loss while traveling in the media, to minimize the transmissive light-guiding element 32 can also increase the total light outputted from the first surface 321.

In this embodiment, the first surface 321 and the second surface 322 are planar surfaces, and they are in parallel with each other.

The transmissive light-guiding element 32 can be formed by one or more elements. For example, the transmissive light-guiding element 32 may be formed by a single glass or acrylic plate, or it may include two plates made of different materials, such as a glass plate and an acrylic plate. In general, the refractive index of the glass plate is approximate between 1.48 and 2.0, and that of the acrylic plate is approximate larger than 1.48.

As shown in FIG. 3C, the transmissive light-guiding element 32 includes a first element 326 and a second element 327. The first element faces the barcode 41, and the second element face the image capturing module 33. A surface of the first element 326 facing the barcode 41 can be defined as the first surface 321, and a surface of the second element 327 facing the image capturing module 33 can be defined as the second surface 322.

The material of the first element 326 and the second element are a glass and acrylic respective for example. The glass plate is more durable and harder than the acrylic plate, so that the lifespan and protection of the transmissive light-guiding element 32 can be improved.

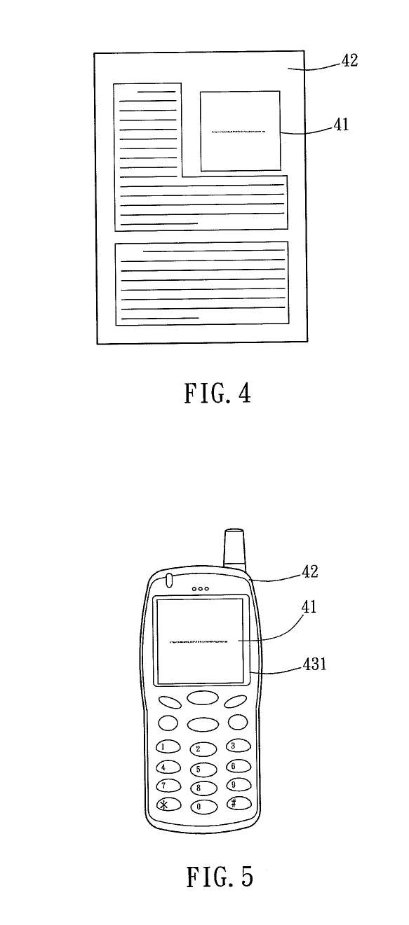

The barcode 41 is a 2-D barcode that is printed on a publication 42 (see FIG. 4) or shown on a display 431 of a portable communication device 43 (see FIG. 5). The white balance properties of the publication and the display of the portable communication device are greatly different, so that the conventional barcode scanner is designed for reading either the barcode printed on the publication or the barcode shown on the display of the portable communication device. Compared with the conventional barcode scanner, the barcode reading device 3 of the invention can perfectly read the barcode printed on the publication and the barcode shown on the display of the portable communication device.

The operation of the barcode reading device 3 will be described hereinafter.

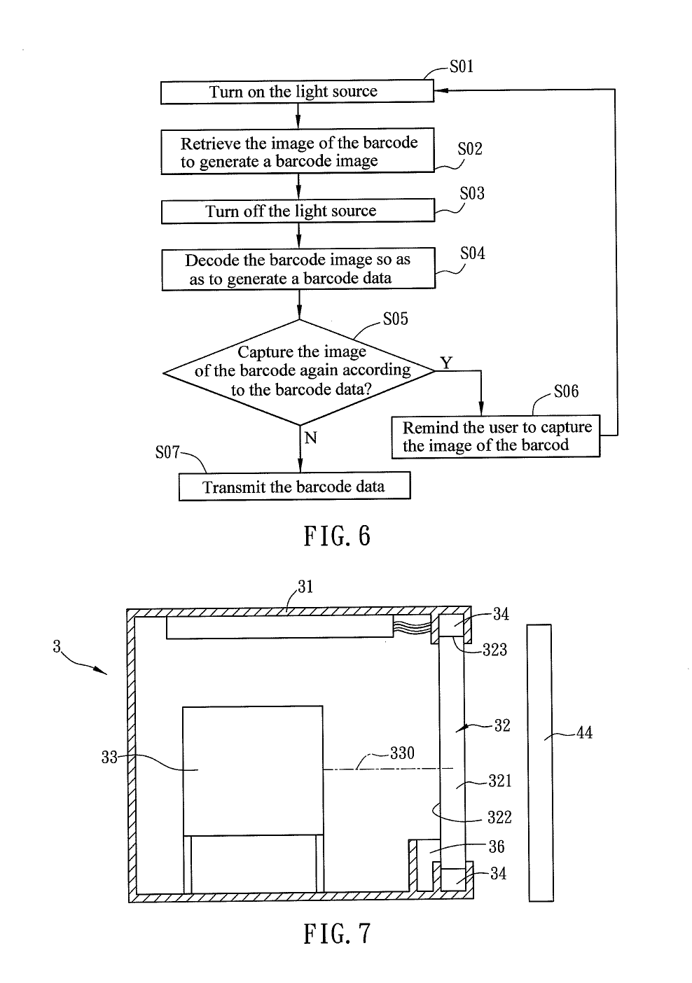

As shown in FIG. 6, the barcode reading method of the barcode reading device 3 includes steps S01 to S07.

In the step S01, the light control element 35 controls to turn on the light source 34. The light source does not emit light before being turned on, and starts to emit light afterward. The light emitted by the light source 34 is not a flash and can be kept for a while. In general, the lighting period of the light source 34 is longer than the period that is necessary for the image capturing module 33 to capture the image.

In the step S02, the image capturing module 33 retrieves the image of the barcode 41 to generate a barcode image.

In the step S03, the light control element 35 controls to turn off the light source 34.

The step S04 is to decode the barcode image so as to generate a barcode data. This step S04 can be carried out by a decoding circuit, which may be configured inside or outside the barcode reading device 3.

The step S05 is to determine whether to capture the image of the barcode again according to the barcode data. If yes, the step S06 is then performed; otherwise, if no, the step S07 is then performed. The step S05 can be carried out by a control circuit, which may be configured inside or outside the barcode reading device 3.

The step S06 is to remind the user to capture the image of the barcode again, and to instruct the user to position the object with the barcode at a suitable place. Then, the step S01 is performed again.

The step S07 is to transmit the barcode data to, for example, a data process system for later procedures.

Referring to FIG. 7, the barcode reading device 3 further includes a detecting element 36, which is disposed adjacent to the transmissive light-guiding element 32 for detecting an object 44 moving toward the barcode reading device 3 within a predetermined distance. This can detect that whether the object 44 moves within a predetermined distance or not.

The object 44 may be a user, a publication held by the user, or a portable communication device held by the user. FIG. 4 shows a publication held by the user, and the barcode is printed on the publication. FIG. 5 shows a portable communication device held by the user, and the barcode is shown on the display of the portable communication device.

If the distance between the object 44 and the detecting element 36 is smaller than a predetermined distance, the detecting element 36 generates a detecting signal. The light control element controls the light source to emit light according to the detecting signal.

The detecting element 36 can be a non-contact detecting element such as an optical detector or radar. Of course, the detecting element 36 can be a contact detecting element such as a touch panel or a bottom.

For example, the detecting element 36 is disposed on the second surface of the transmissive light-guiding element 32. When the user moves the portable communication device or publication toward the first surface 321, the detecting element 36 will detect the portable communication device or publication, and then the barcode reading device 3 starts to operate. Alternatively, the detecting element 36 can be disposed on the first surface 321 of the transmissive light-guiding element 32 or the case 31.

The operation of the barcode reading device 3 of FIG. 7 will be described hereinafter.

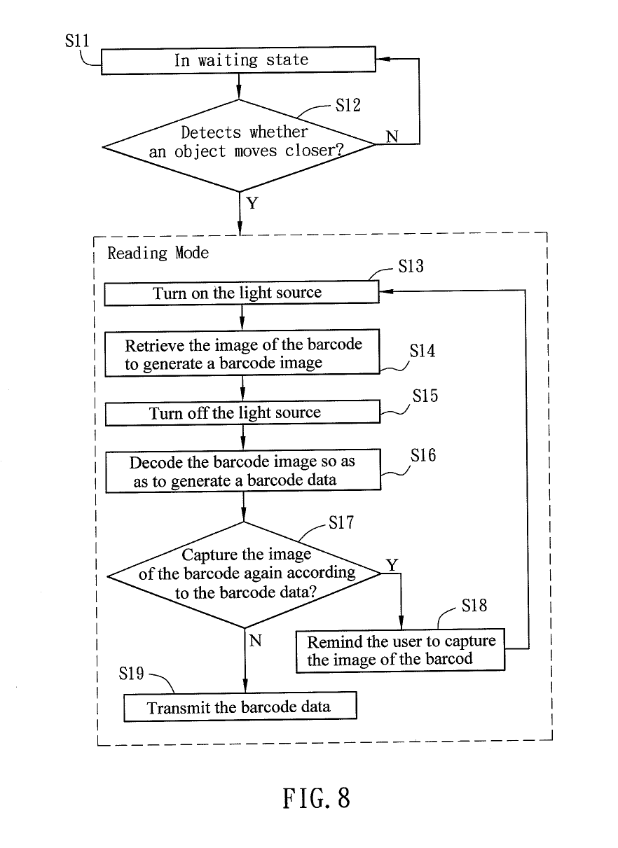

As shown in FIG. 8, the operation of the barcode reading device 3 of FIG. 7 includes the following steps S11 to S19.

In step S11, the barcode reading device 3 is in a waiting state. In the waiting state, most components of the barcode reading device 3, such as the image capturing module 33, the light source 34, etc., are not in the operating state, but the detecting element 36 is in the operating state.

In the step S12, the detecting element 36 detects whether an object moves closer. If not, the flow goes back to the step S11, wherein the barcode reading device 3 is still in the waiting state. If yes, the barcode reading device 3 enters an image capturing mode, which includes the steps S13 to S19. The steps S13 to S19 are similar to the steps S01 to S07 mentioned hereinabove, so the detailed description thereof will be omitted.

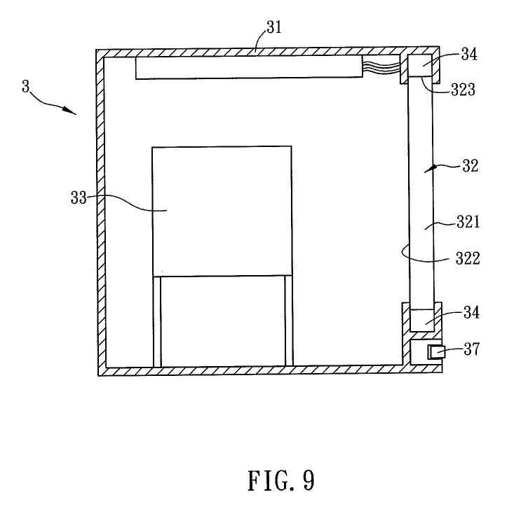

Referring to FIG. 9, the barcode reading device 3 further includes a switch element 36 such as a bottom. The switch element 36 is disposed on the case 31 for changing the operation mode of the barcode reading device 3. For example, when the barcode reading device 3 is in the waiting mode, the user may trigger the switch element 37 to enable the barcode reading device 3 to enter the image capturing mode.

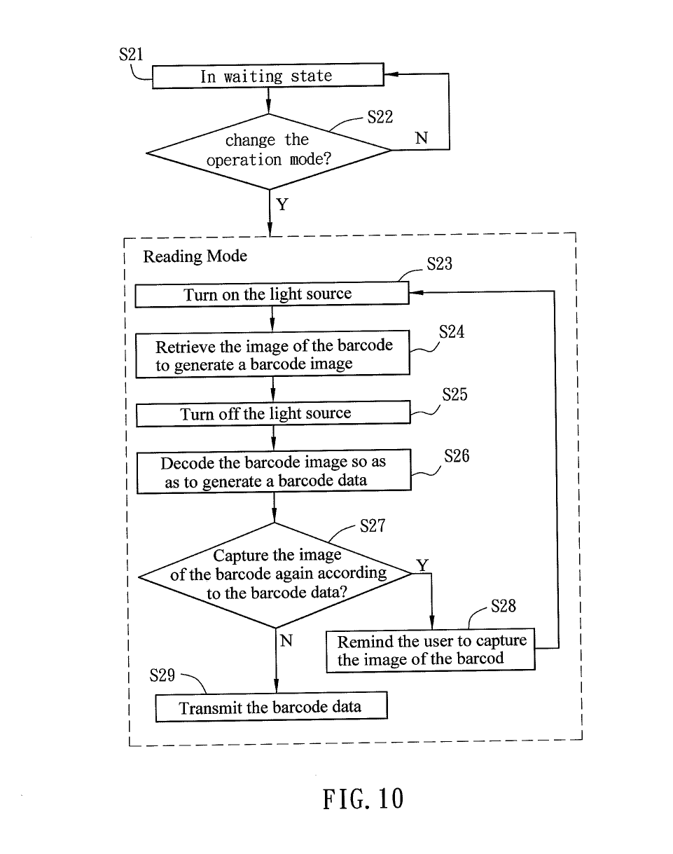

As shown in FIG. 10, the operation flow of the barcode reading device 3 shown in FIG. 9 includes the following steps S21 to S29.

In step S21, the barcode reading device 3 is in a waiting state. In the waiting state, most components of the barcode reading device 3, such as the image capturing module 33, the light source 34, etc., are not in the operating state, but the switch element 37 is in the operating state.

The step S22 is to determine whether to change the operation mode of the barcode reading device 3 according to the state of the switch element 37. If not to change, the flow goes back to the step S21, wherein the barcode reading device 3 is still in the waiting state. If yes, the barcode reading device 3 enters an image capturing mode, which includes the steps S23 to S29. The steps S23 to S29 are similar to the steps S01 to S07 mentioned hereinabove, so the detailed description thereof will be omitted.

To make the invention more comprehensive, the detailed aspects of the light source 34 will be described hereinafter.

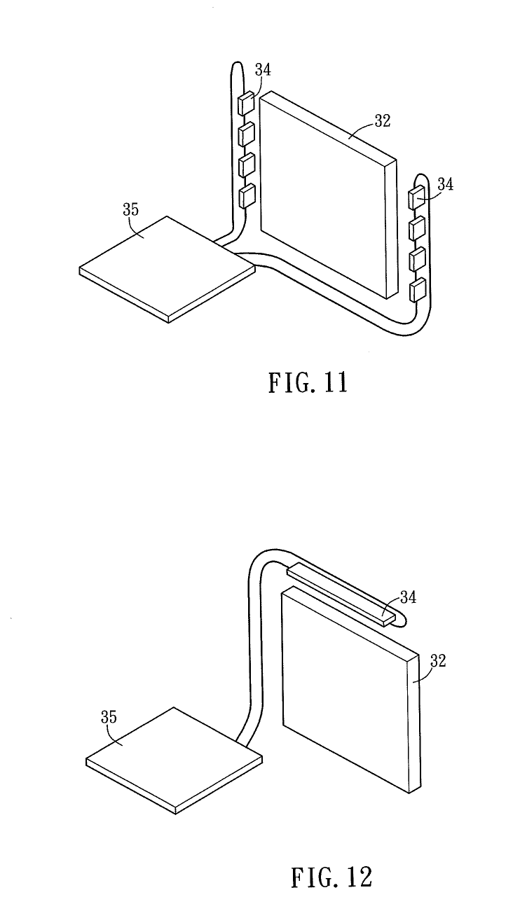

As shown in FIG. 11, the light source 34 includes a plurality of light emitting diodes (LED), which are disposed adjacent to the connecting surfaces 323 and 324 of the transmissive light-guiding element 32. The LEDs are electrically connected with each other. For example, the LEDs disposed adjacent to one of the connecting surfaces are connected in series, and are electrically connected with the light control element 35 through wires. As shown in FIG. 12, the LED is installed on a substrate, which has some traces, and the LED is electrically connected with the light control element 35 through the traces.

The LEDs may be disposed adjacent to only one side of the transmissive light-emitting element 32, two opposite connecting surfaces of the transmissive light-emitting element 32, or four connecting surfaces of the transmissive light-emitting element 32.

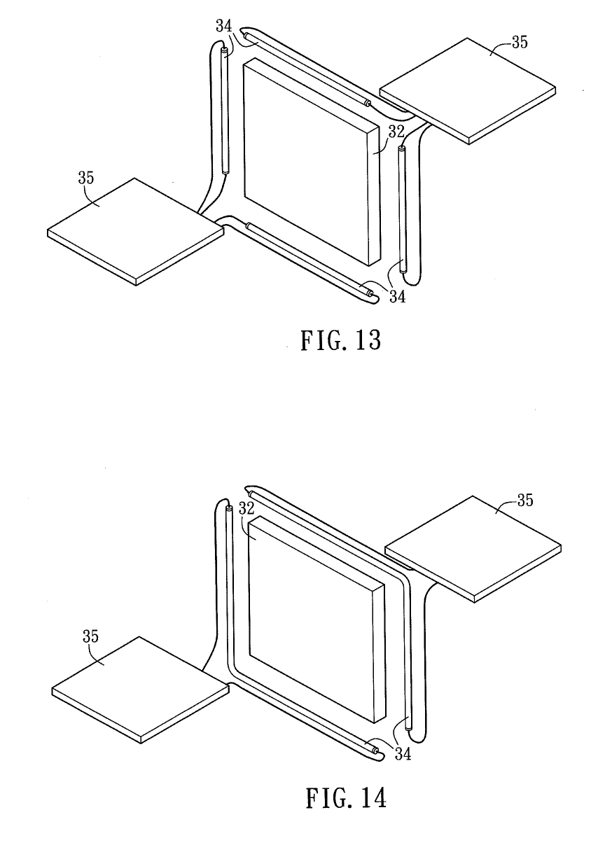

Referring to FIGS. 13 to 15, the light source 34 is a lamp, such as a cold cathode fluorescent lamp (CCFL). As shown in FIG. 13, the light source 34 includes several linear lamps that are disposed adjacent to the four connecting surfaces of the transmissive light-guiding element 32. Of course, the light source 34 can be disposed at one connecting surface or two opposite connecting surfaces.

As shown in FIG. 14, the light source 34 includes two L-shaped lamps which are disposed adjacent to four connecting surfaces of the transmissive light-guiding element 32. Of course, the light source 34 may include one L-shaped lamp disposed adjacent to two connecting surfaces of the transmissive light-guiding element 32.

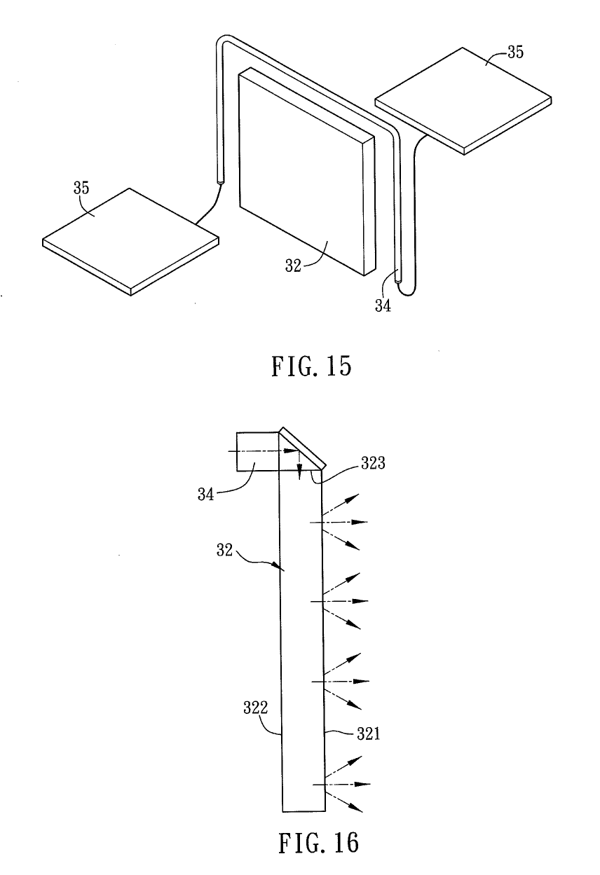

As shown in FIG. 15, the light source 34 include a U-shaped lamp which is disposed adjacent to three connecting surfaces of the transmissive light-guiding element 32. In addition, it is also possible to dispose a linear lamp adjacent to the rest one connecting surface of the transmissive light-guiding element 32.

As shown in FIG. 16, the light source 34 includes a light emitting element 341 and a light guiding element 342 such as a reflective mirror or a light guiding rod. The light emitting element 341 can be a lamp or a LED as mentioned in the previous aspects.

To make the invention more comprehensive, the detailed aspects of the image capturing module will be described hereinafter.

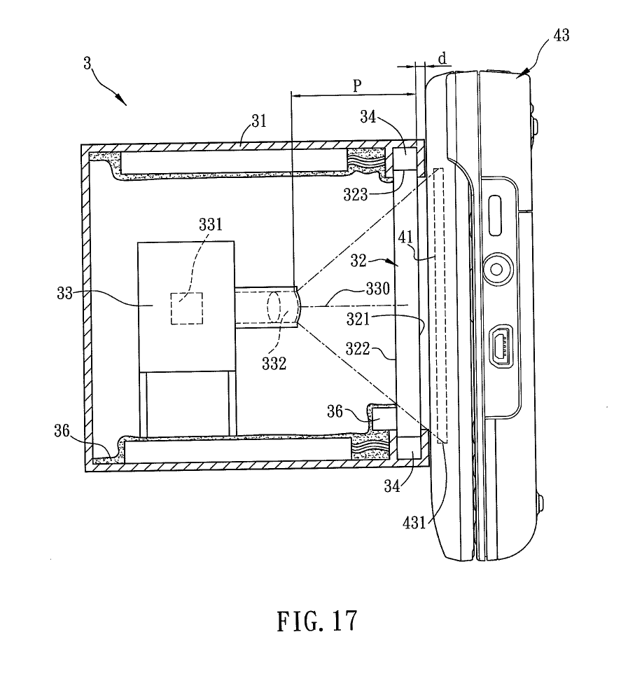

With reference to FIG. 17, the image capturing module 33 includes an image sensing element 331 and a lens 332. The distance d between the barcode 41 and the first surface 321 is smaller than the depth of field (DOF) of the lens 332. For example, the imaging distance from the barcode 41 to the lens 332 is ranged between 100% and 130% of the shortest optical path P, which is the shortest path between the lens 332 and the first surface 321.

In this embodiment, the barcode 41 is shown on the display 431 of the portable communication device 43 as shown in FIG. 6. The distance d between the display 431 and the first surface 321 is smaller than the DOF of the lens 332.

The image sensing element 331 can be a CCD (Charge Couple Device) or a CMOS (Complementary Metal Oxide Semiconductor) image sensor.

When the detecting element 36 detects that the distance between the barcode 41 and the first surface 321 of the transmissive light-guiding element 32 is smaller than the DOF of the lens, it generates a detecting signal. The barcode reading device can enter the image capturing mode according to the detecting signal. The image capturing mode has been illustrated in the previous embodiment, so the detailed description thereof will be omitted.

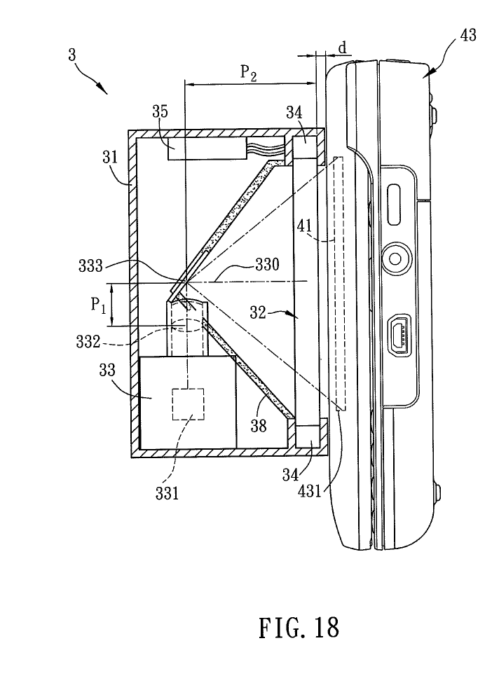

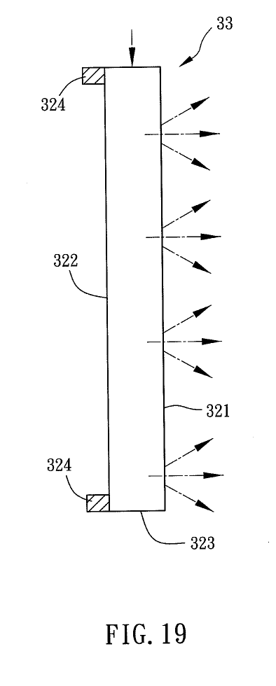

As shown in FIG. 18, the image capturing module 33 further includes a reflective element 333, such as a reflective mirror. The reflective element 333 can reflect the light beam from the barcode 41 to the lens 332.

The shortest optical path P between the lens 332 and the first surface 321 can be described as follow equation:

P=P1+P2

Wherein, P1 is the shortest optical path between the lens 332 and the reflective element 333, and P2 is the shortest optical path between the reflective element 333 and the first surface 321. The distance from the barcode 41 to the first surface 321 is smaller than the DOF of the lens 332. For example, the imaging distance from the barcode 41 to the lens 332 is ranged between 100% and 130% of the shortest optical path P.

In this embodiment, the barcode 41 is shown on the display 431 of the portable communication device 43 as shown in FIG. 6. The distance d between the display 431 and the first surface 321 is smaller than the DOF of the lens 332.

In the embodiment with reference to FIGS. 17 and 18, the barcode reading device 3 further includes a light absorbing element 38 disposed inside the case 31. The configuration of the light absorbing element 38 can prevent the reflected light inside the case 31, so that the image capturing procedure of the image capturing module 33 will not be interfered by the reflected light in the case 31. The light absorbing element 38 can be a dark-color tap, foam, case, or coating.

As shown in FIG. 17, the light absorbing element 38 is disposed on the surface of the case 31 or the light control element 35. As shown in FIG. 18, the light absorbing element 38 has a funnel shape.

To make the invention more comprehensive, the detailed aspects of the transmissive light-guiding element will be described hereinafter.

Referring to FIG. 19, the second surface 322 includes a reflective area and a light passing area, which is disposed facing the image capturing module 33.

The reflective area can reflect the light beam within the transmissive light-guiding element 32, so that the light outputted from the first surface 321 can be increased. The location of the reflective area should not block the image capturing module 33 while it captures the image of the barcode 41.

The transmissive light-guiding element 32 includes a reflective body 324 disposed on the reflective area of the second surface. In addition, the reflective area of the second surface may have a roughness surface or be formed with microstructures.

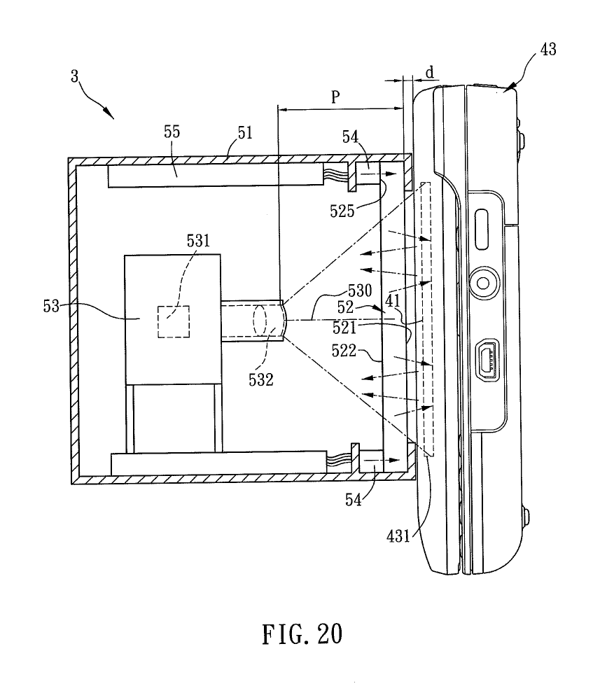

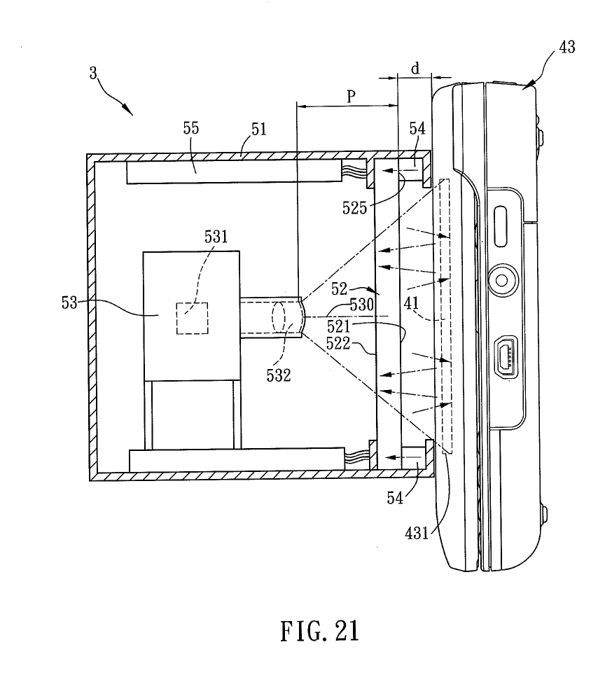

With reference to FIGS. 20 and 21, a barcode reading device 5, which is used for reading a barcode 41, includes a case 51, a transmissive light-guiding element 52, an image capturing module 53, a light source 54, and a light control element 55.

The case 51 has an opening 511. The transmissive light-guiding element 52 is disposed adjacent to the opening 511 and has a first surface 521 and a second surface 522 disposed opposite to each other. The first surface is disposed facing the barcode 41, and the second surface 522 is disposed facing the image capturing module 53. The image capturing module 53 is disposed in the case 51 and captures an image of the barcode 41 through the second surface 522 and the first surface 521. The light source 54 emits a light beam to the first surface 521 and the second surface 522. The light control element 55 controls the ON/OFF of the light source 54. An incident light axis 530 of the image capturing module 53 is perpendicular to the second surface 522.

When the light source 54 emits a light beam to the first surface 521, the light source 54 and the first surface 521 may be separated with a distance for the purpose of heat dissipation. In order to allow most of the light beam emitted by the light source 54 to enter the first surface 521 rather than be reflected by the first surface 521, the distance between the light source 54 and the first surface 521 should not be too large. Moreover, if the heat dissipation efficiency can be enhanced, the light source 54 and the connecting surface 521 may be contact with each other. This consideration will be also applied to the case as the light emitted from the light source 54 to the second surface 522.

In this embodiment, the barcode 41 is shown on the display 431 of the portable communication device 43 as shown in FIG. 6. Of course, the barcode 41 can be printed on a publication.

The image capturing module 53 includes an image sensing element 531 and a lens 532. The image sensing element 531 is used to retrieve the image of the barcode 41. The distance d between the barcode 41 and the first surface 521 is smaller than the DOF of the lens 532.

As shown in FIG. 20, the light source 54 emits the light beam to an edge area of the second surface 522, and the transmissive light-guiding element 52 can guide the inputted light beam toward the first surface 521. The barcode 41 reflects the light beam outputted from the first surface 521, and the reflected light beam passes through the first surface 521 and the second surface 522 in order.

As shown in FIG. 21, the light source 54 emits the light beam to an edge area of the first surface 521, and the transmissive light-guiding element 52 can guide the inputted light beam toward the first surface 521. The barcode 41 reflects the light beam outputted from the first surface 521, and the reflected light beam passes through the first surface 521 and the second surface 522 in order.

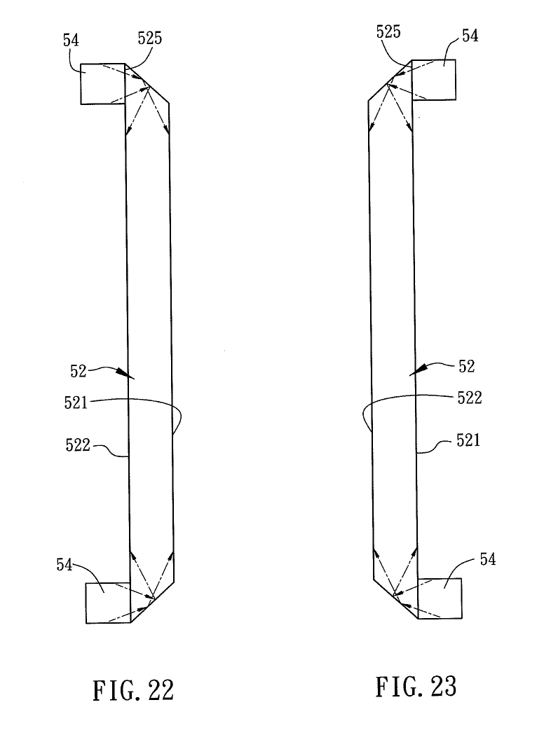

Referring to FIGS. 22 and 23, the transmissive light-guiding element 52 has an inclined surface 525, which is used as a reflective surface. As shown in FIG. 22, the light beam emitted from the light source 54 is reflected by the inclined surface 525 to the second surface 522. As shown in FIG. 23, the light beam emitted from the light source 54 is reflected by the inclined surface 524 to the first surface 521. In FIGS. 22 and 23, the characteristics of the first surface 521 and the second surface 522 are the same as the first surface 321 and the second surface 322 of the previous embodiments, so that the light beam entering the transmissive light-guiding element 52 can travel between the first surface 521 and the second surface 522, and then be outputted through the first surface 521.

To be noted, the changes and modifications of the barcode reading device 5 of this embodiment are the same as or similar to those of the previous embodiments, so the detailed descriptions thereof will be omitted.

To sum up, in the barcode reading device of the present invention, the light beam emitted from the light source enters the transmissive light-guiding element, and the transmissive light-guiding element can guide the entered light beam to the first surface, so that the total light quantity reaching the first surface can be increased. The light beam towards the first surface can be reflected by the barcode, and the reflected light beam passes through the first surface to enter the transmissive light-guiding element and is then outputted through the second surface. After that, the image capturing module can retrieve the light beam reflected by the barcode so as to capture the image of the barcode. Accordingly, the barcode reading device of the present invention can be suitable for two or more objects with different white balance properties, so that it can perfectly recognize the barcodes shown on different objects.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A barcode reading device for reading a barcode, comprising:
a case having an opening;
a transmissive light-guiding element disposed adjacent to the opening and having a first surface, a second surface and a connecting surface for connecting the first surface and the second surface;
an image capturing module disposed in the case and capturing an image of the barcode through the second surface and the first surface;
a light source emitting a light beam to the connecting surface; and
a light control element controlling the ON/OFF of the light source.

2. The barcode reading device according to claim 1, wherein an incident light axis of the image capturing module is perpendicular to the second surface.

3. The barcode reading device according to claim 1, further comprising:
a detecting element disposed adjacent to the transmissive light-guiding element for detecting an object moving toward the barcode reading device within a predetermined distance.

4. The barcode reading device according to claim 3, wherein the object is a user, a publication held by the user, or a portable communication device held by the user.

5. The barcode reading device according to claim 4, wherein the barcode is printed on the publication.

6. The barcode reading device according to claim 4, wherein the barcode is displayed on a display of the portable communication device.

7. The barcode reading device according to claim 1, wherein the transmissive light-guiding element guides the inputted light beam toward a first surface, the light beam is outputted from the first surface and then reflected by the barcode, and the light beam reflected by the barcode passes through the first surface and the second surface in order.

8. The barcode reading device according to claim 1, wherein the light source is a light emitted diode or a fluorescent lamp.

9. The barcode reading device according to claim 1, wherein the image capturing module comprises an image sensing element and a lens.

10. The barcode reading device according to claim 9, wherein the image sensing element is a CCD or a CMOS image sensor.

11. The barcode reading device according to claim 9, wherein the distance between the barcode and the first surface is smaller than the depth of field of the lens.

12. The barcode reading device according to claim 1, wherein the material of the transmissive light-guiding element comprises glass or plastic.

13. The barcode reading device according to claim 1, wherein the transmissive light-guiding element is solid and transparent, and has a refractive index larger than 1.4.

14. The barcode reading device according to claim 1, wherein the second surface has a reflective area and a penetrative area facing the image capturing module.

15. The barcode reading device according to claim 1, wherein the transmissive light-guiding element has a reflective body disposed on the second surface.

16. The barcode reading device according to claim 1, further comprising:
a light absorbing element disposed inside the case.

17. The barcode reading device according to claim 1, wherein the transmissive light-guiding element comprises:
a first element, having a surface facing the barcode as the first surface; and
a second element, having a surface facing the image capturing module as the second surface

18. The barcode reading device according to claim 1, wherein the material of the first element is glass, and the material of the second element is acrylic.

19. A barcode reading device for reading a barcode, comprising:
a case having an opening;
a transmissive light-guiding element disposed adjacent to the opening and having a first surface and a second surface disposed opposite to each other;
an image capturing module disposed in the case and capturing an image of the barcode through the second surface and the first surface;
a light source emitting a light beam to the first surface and the second surface; and
a light control element controlling the ON/OFF of the light source.

20. The barcode reading device according to claim 19, wherein the image capturing module captures an image of the barcode through the second surface and the first surface.
